(19) United States
(12) Patent Application Publication
(10) Pub. No.: US 2017/0094598 A1
(43) Pub. Date: Mar. 30, 2017

(54) Device and Method of handling Power Preference

(71) Applicant: HTC Corporation, Taoyuan City (TW)

(72) Inventor: Te-Ming Chen, Taoyuan City (TW)

(21) Appl. No.: 15/273,699

(22) Filed: Sep. 22, 2016

Related U.S. Application Data
(60) Provisional application No. 62/222,782, filed on Sep. 24, 2015.

(51) Int. Cl. H04W 52/02; H04W 76/02

(52) U.S. Cl. CPC H04W 52/0212; H04W 52/0235; H04W 76/028

(57) ABSTRACT

A communication device for handling a power preference comprises a storage unit for storing instructions and a processing circuit coupled to the storage unit. The processing circuit is configured to execute the instructions stored in the storage unit. The instructions comprise receiving a first powerPrefIndicationConfig set to Setup from a network; transmitting a first powerPrefIndication set to Normal to the network, after receiving the first powerPrefIndicationConfig; starting or restarting a timer T340; and stopping the timer T340, if the communication device receives a second powerPrefIndicationConfig set to Release or Setup from the network, or if the communication device transmits a second powerPrefIndication set to lowPowerConsumption to the network after receiving a third powerPrefIndicationConfig set to Setup from the network.

### CROSS REFERENCE TO RELATED APPLICATIONS

This application claims the benefit of U.S. Provisional Application No. 62/222,782, filed on Sep. 24, 2015, which is incorporated herein by reference.

### BACKGROUND OF THE INVENTION

1. Field of the Invention

The present invention relates to a communication device and a method used in a wireless communication system, and more particularly, to a communication device and a method of handling power preference in a wireless communication system.

2. Description of the Prior Art

A long-term evolution (LTE) system provides high data rate, low latency, packet optimization, and improved system capacity and coverage. In the LTE system, a radio access network known as an evolved universal terrestrial radio access network (E-UTRAN) includes at least one evolved Node-B (eNB) for communicating with at least one user equipment (UE), and for communicating with a core network including a mobility management entity (MME), a serving gateway, etc., for Non-Access Stratum (NAS) control.

A LTE-advanced (LTE-A) system, as its name implies, is an evolution of the LTE system. The LTE-A system targets faster switching between power states, improves performance at the coverage edge of an eNB, increases peak data rate and throughput, and includes advanced techniques, such as carrier aggregation (CA), coordinated multipoint (CoMP) transmissions/reception, uplink (UL) multiple-input multiple-output (UL-MIMO), licensed-assisted access (LAA) using LTE, etc. For a UE and an eNB to communicate with each other in the LTE-A system, the UE and the eNB must support standards developed for the LTE-A system, such as the 3GPP Rel-10 standard or later versions.

According to the prior art, a power preference of the UE may be Normal or lowPowerConsumption, when the UE is in a RRC_CONNECTED state and a timer is running. That is, the timer may be running, when the power preference of the UE is lowPowerConsumption. However, the UE cannot change the power preference from lowPowerConsumption to Normal when the timer is running according to the prior art. Inconvenience is caused to operation of the UE. Thus, how to handle a power preference procedure is an important problem to be solved.

### SUMMARY OF THE INVENTION

The present invention therefore provides a communication device and a method for handling power preference to solve the abovementioned problem.

A communication device for handling a power preference comprises a storage unit for storing instructions and a processing circuit coupled to the storage unit. The processing circuit is configured to execute the instructions stored in the storage unit. The instructions comprise receiving a first powerPrefIndicationConfig set to Setup from a network; transmitting a first powerPrefIndication set to Normal to the network, after receiving the first powerPrefIndicationConfig; starting or restarting a timer T340; and stopping the timer T340, if the communication device receives a second powerPrefIndicationConfig set to Release or Setup from the network, or if the communication device transmits a second powerPrefIndication set to lowPowerConsumption to the network after receiving a third powerPrefIndicationConfig set to Setup from the network.

A communication device for handling a power preference comprises a storage unit for storing instructions and a processing circuit coupled to the storage unit. The processing circuit is configured to execute the instructions stored in the storage unit. The instructions comprise receiving a first powerPrefIndicationConfig set to Setup from a network; transmitting a first powerPrefIndication set to Normal to the network, after receiving the first powerPrefIndicationConfig; starting or restarting a timer T340; transmitting a second powerPrefIndication set to lowPowerConsumption to the network after receiving a second powerPrefIndicationConfig set to Setup from the network; and transmitting a third powerPrefIndication set to Normal to the network whether the timer T340 is running or not.

A communication device for handling a power preference comprises a storage unit for storing instructions and a processing circuit coupled to the storage unit. The processing circuit is configured to execute the instructions stored in the storage unit. The instructions comprise receiving a first powerPrefIndicationConfig set to Setup from a network; transmitting a first powerPrefIndication set to Normal to the network, after receiving the first powerPrefIndicationConfig; starting or restarting a timer T340; transmitting a second powerPrefIndication set to lowPowerConsumption to the network, after receiving a second powerPrefIndicationConfig set to Setup from the network; and transmitting a third powerPrefIndication set to Normal to the network, if the timer 340 is expired, if the communication device performs a radio resource control (RRC) connection re-establishment procedure, or if the communication device enters a RRC_IDLE state.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an example of the present invention.

FIG. 2 is a schematic diagram of a communication device according to an example of the present invention.

FIG. 3 is a flowchart of a process according to an example of the present invention.

FIG. 4 is a flowchart of a process according to an example of the present invention.

FIG. 5 is a flowchart of a process according to an example of the present invention.

FIG. 6 is a flowchart of a process according to an example of the present invention.

### DETAILED DESCRIPTION

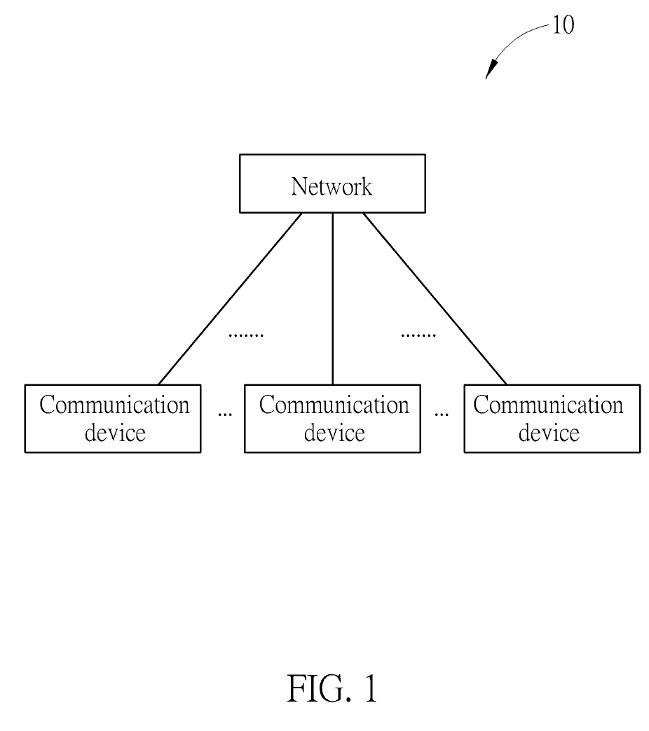

FIG. 1 is a schematic diagram of a wireless communication system 10 according to an example of the present invention. The wireless communication system 10 is briefly composed of a network and a plurality of communication devices. In FIG. 1, the network and the communication devices are simply utilized for illustrating the structure of the wireless communication system 10. Practically, the network may be a universal terrestrial radio access network (UTRAN) comprising at least one Node-B (NB) and/or a Radio Network Controller (RNC) in a universal mobile telecommunications system (UMTS). In one example, the network may be an evolved UTRAN (E-UTRAN) comprising at least one evolved NB (eNB) and/or at least one relay in a long term evolution (LTE) system, a LTE-Advanced (LTE-A) system or an evolution of the LTE-A system. In another example, the network may be a fifth generation (5G) network including at least one 5G base station (BS) which employs orthogonal frequency-division multiplexing (OFDM) and/or non-OFDM, and transmission time interval smaller than 1 millisecond (ms) for communication with the communication devices. In general, a base station (BS) may also be used to refer any of the NB, the RNC, the eNB and the 5G BS.

A communication device can be a user equipment (UE), a low cost device (e.g., machine type communication (MTC) device), a mobile phone, a laptop, a tablet computer, an electronic book, a portable computer system, a vehicle or aircraft. In addition, the network and the communication device can be seen as a transmitter or a receiver according to direction (i.e., transmission direction), e.g., for an uplink (UL), the communication device is the transmitter and the network is the receiver, and for a downlink (DL), the network is the transmitter and the communication device is the receiver.

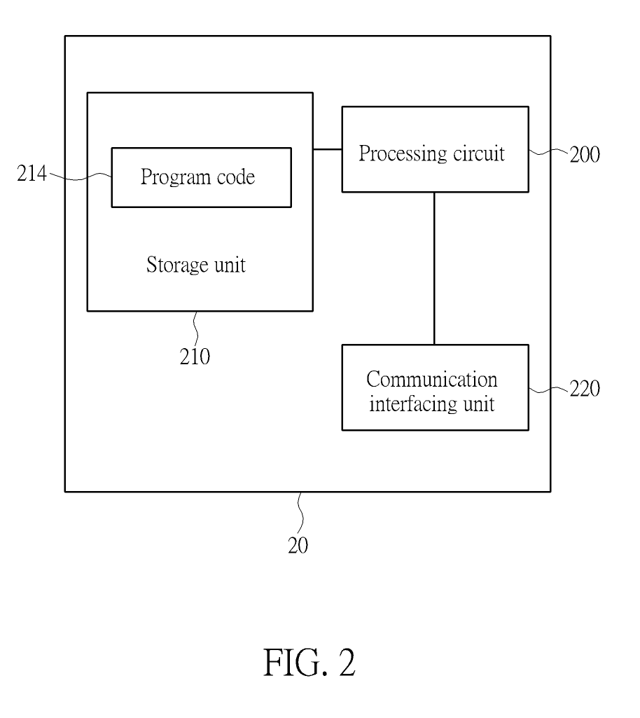

FIG. 2 is a schematic diagram of a communication device 20 according to an example of the present invention. The communication device 20 may be a communication device or the network shown in FIG. 1, but is not limited herein. The communication device 20 may include a processing circuit 200 such as a microprocessor or Application Specific Integrated Circuit (ASIC), a storage unit 210 and a communication interfacing unit 220. The storage unit 210 may be any data storage device that may store a program code 214, accessed and executed by the processing circuit 200. Examples of the storage unit 210 include but are not limited to a subscriber identity module (SIM), read-only memory (ROM), flash memory, random-access memory (RAM), hard disk, optical data storage device, non-volatile storage unit, non-transitory computer-readable medium (e.g., tangible media), etc. The communication interfacing unit 220 is preferably a transceiver and is used to transmit and receive signals (e.g., data, signals, messages and/or packets) according to processing results of the processing circuit 200.

In the following embodiments, a UE is used to represent a communication device in FIG. 1, to simplify the illustration of the embodiments.

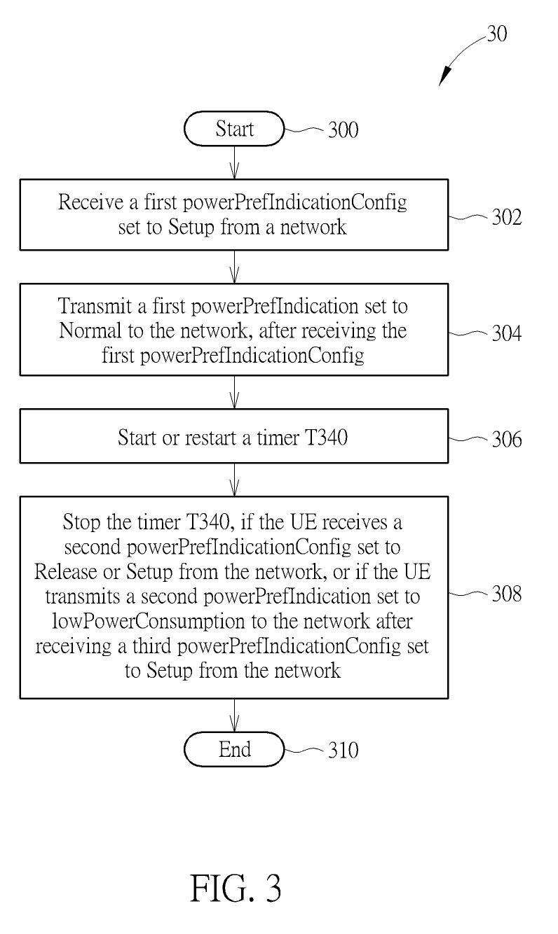

FIG. 3 is a flowchart of a process 30 according to an example of the present invention. The process 30 may be utilized in a UE for handling a power preference. The process 30 may be compiled into the program code 214 and includes the following steps:

Step 300: Start.

Step 302: Receive a first powerPrefIndicationConfig set to Setup from a network.

Step 304: Transmit a first powerPrefIndication set to Normal to the network, after receiving the first powerPrefIndicationConfig.

Step 306: Start or restart a timer T340.

Step 308: Stop the timer T340, if the UE receives a second powerPrefIndicationConfig set to Release or Setup from the network, or if the UE transmits a second powerPrefIndication set to lowPowerConsumption to the network after receiving a third powerPrefIndicationConfig set to Setup from the network.

Step 310: End.

According to the process 30, the UE may receive a first powerPrefIndicationConfig set to Setup from a network. The UE may transmit a first powerPrefIndication set to Normal to the network, after receiving the first powerPrefIndicationConfig. Then, the UE may start or restart a timer T340. After a while, the UE may stop the timer T340, if the UE receives a second powerPrefIndicationConfig set to Release or Setup from the network, or if the UE transmits a second powerPrefIndication set to lowPowerConsumption to the network after receiving a third powerPrefIndicationConfig set to Setup from the network. Thus, in one example, the UE may transmit a third powerPrefIndication set to Normal to the network, after stopping the timer T340. In another example, the UE may transmit the third powerPrefIndication to the network when receiving a fourth powerPrefIndicationConfig set to Setup, after stopping the timer T340 and receiving a fifth powerPrefIndicationConfig set to Release from the network. That is, the UE stops the timer 340, to change its power preference from lowPowerConsumption to Normal. Thus, the problem of setting the power preference when the timer T340 is running is solved according to the process 30.

Realization of the process 30 is not limited to the above description. The following examples may be applied to the process 30.

In one example, the first powerPrefIndication, the second powerPrefIndication, and the third powerPrefIndication may be included in a UEAssistanceInformation message. That is, the UE may transmit the UEAssistanceInformation message including a powerPrefIndication (e.g., the first powerPrefIndication, the second powerPrefIndication, or the third powerPrefIndication) to the network for indicating a power preference. In one example, the UE may receive a sixth powerPrefIndicationConfig set to Release from the network, before receiving the third powerPrefIndicationConfig. Please note that, the third powerPrefIndicationConfig and the sixth powerPrefIndicationConfig may be transmitted by different cells of the network. In one example, the UE may receive three powerPrefIndicationConfigs (e.g., the first powerPrefIndicationConfig, the sixth powerPrefIndicationConfig, the third powerPrefIndicationConfig) in sequence from the network, which are set to Setup, Release and Setup, respectively.

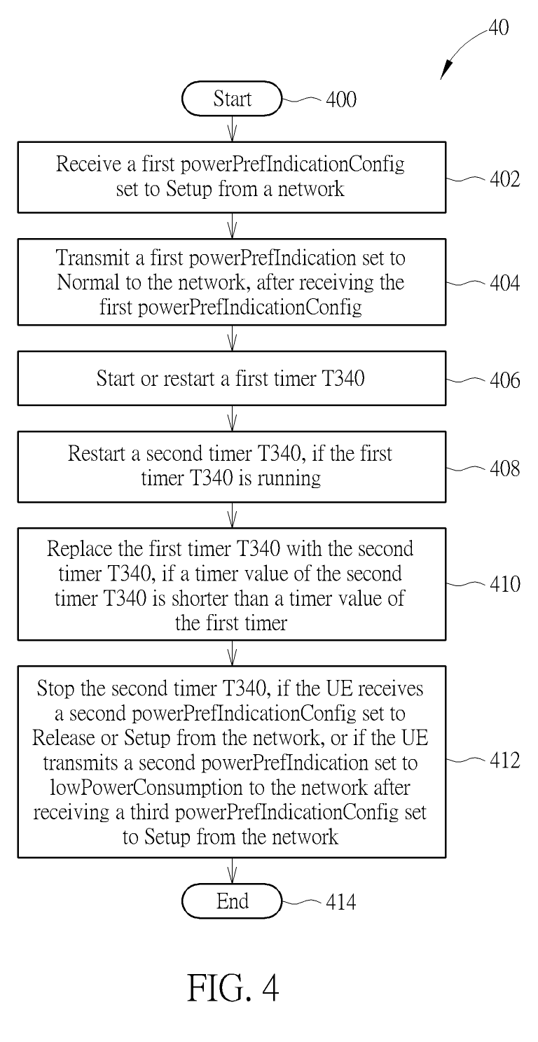

FIG. 4 is a flowchart of a process 40 according to an example of the present invention. The process 40 may be utilized in a UE for handling a power preference. The process 40 may be compiled into the program code 214 and includes the following steps:

Step 400: Start.

Step 402: Receive a first powerPrefIndicationConfig set to Setup from a network.

Step 404: Transmit a first powerPrefIndication set to Normal to the network, after receiving the first powerPrefIndicationConfig.

Step 406: Start or restart a first timer T340.

Step 408: Restart a second timer T340, if the first timer T340 is running.

Step 410: Replace the first timer T340 with the second timer T340, if a timer value of the second timer T340 is shorter than a timer value of the first timer T340.

Step 412: Stop the second timer T340, if the UE receives a second powerPrefIndicationConfig set to Release or Setup from the network, or if the UE transmits a second powerPrefIndication set to lowPowerConsumption to the network after receiving a third powerPrefIndicationConfig set to Setup from the network.

Step 414: End.

According to the process 40, the UE may receive a first powerPrefIndicationConfig set to Setup from a network. The UE may transmit a first powerPrefIndication set to Normal to the network, after receiving the first powerPrefIndicationConfig. Then, the UE may start or restart a timer T340. The UE may restart a second timer T340, if the first timer T340 is running. The UE may compare a timer value of the second timer T340 with a timer value of the first timer T340. The UE may replace the first timer T340 with the second timer T340, if the timer value of the second timer T340 is shorter than the timer value of the first timer T340. After a while, the UE may stop the second timer T340, if the UE receives a second powerPrefIndicationConfig set to Release or Setup from the network, or if the UE transmits a second powerPrefIndication set to lowPowerConsumption to the network after receiving a third powerPrefIndicationConfig set to Setup from the network. Thus, in one example, the UE may transmit a third powerPrefIndication set to Normal to the network, after stopping the second timer T340. In another example, the UE may transmit the third powerPrefIndication to the network when receiving a fourth powerPrefIndicationConfig set to Setup, after stopping the second timer T340 and receiving a fifth powerPrefIndicationConfig set to Release from the network. That is, the UE stops the second timer T340, to change its power preference from lowPowerConsumption to Normal. Thus, the problem of setting the power preference when the second timer T340 is running is solved according to the process 40.

Realization of the process 40 is not limited to the above description. The following examples may be applied to the process 40.

In one example, the timer value of the second timer T340 may be same as or different from the time value of the first timer T340. In one example, the first powerPrefIndication, the second powerPrefIndication, and the third powerPrefIndication may be included in a UEAssistanceInformation message. That is, the UE may transmit the UEAssistanceInformation message including a powerPrefIndication (e.g., the first powerPrefIndication, the second powerPrefIndication, or the third powerPrefIndication) to the network for indicating a power preference. In one example, the UE may receive a sixth powerPrefIndicationConfig set to Release from the network, before receiving the third powerPrefIndicationConfig. Please note that, the third powerPrefIndicationConfig and the sixth powerPrefIndicationConfig may be transmitted by different cells of the network. In one example, the UE may receive three powerPrefIndicationConfigs (e.g., the first powerPrefIndicationConfig, the sixth powerPrefIndicationConfig, the third powerPrefIndicationConfig) in sequence from the network, which are set to Setup, Release and Setup, respectively.

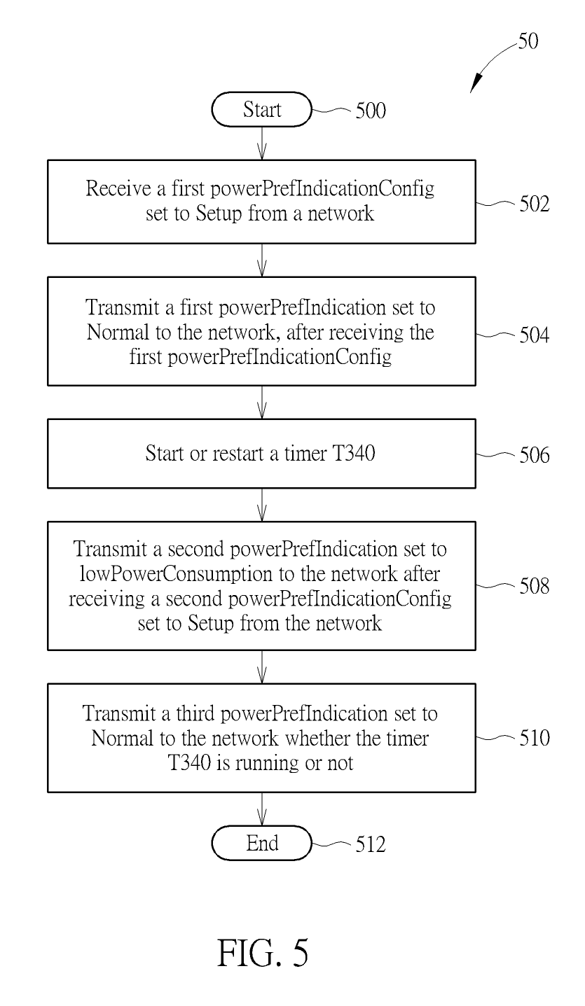

FIG. 5 is a flowchart of a process 50 according to an example of the present invention. The process 50 may be utilized in a UE for handling a power preference. The process 50 may be compiled into the program code 214 and includes the following steps:

Step 500: Start.

Step 502: Receive a first powerPrefIndicationConfig set to Setup from a network.

Step 504: Transmit a first powerPrefIndication set to Normal to the network, after receiving the first powerPrefIndicationConfig.

Step 506: Start or restart a timer T340.

Step 508: Transmit a second powerPrefIndication set to lowPowerConsumption to the network after receiving a second powerPrefIndicationConfig set to Setup from the network.

Step 510: Transmit a third powerPrefIndication set to Normal to the network whether the timer T340 is running or not.

Step 512: End.

According to the process 50, the UE may receive a first powerPrefIndicationConfig set to Setup from a network. The UE may transmit a first powerPrefIndication set to Normal to the network, after receiving the first powerPrefIndicationConfig. Then, the UE may start or restart a timer T340. After a while, the UE may transmit a second powerPrefIndication set to lowPowerConsumption to the network after receiving a second powerPrefIndicationConfig set to Setup from the network. The UE may transmit a third powerPrefIndication set to Normal to the network whether the timer T340 is running or not. That is, the UE changes its power preference from lowPowerConsumption to Normal, even if the timer T340 is running. Thus, the problem of setting the power preference when the timer T340 is running is solved according to the process 50.

Realization of the process 50 is not limited to the above description. The following examples may be applied to the process 50.

In one example, the UE may receive a third powerPrefIndicationConfig set to Release from the network, before receiving the second powerPrefIndicationConfig. Please note that, the second powerPrefIndicationConfig and the third powerPrefIndicationConfig may be transmitted by different cells of the network. In one example, the UE may stop or restart the timer T340, if the timer T340 is running.

In one example, the UE may transmit a fourth powerPrefIndication set to lowPowerConsumption to the network according to whether the timer T340 is running, after transmitting the third powerPrefIndication to the network. In detail, the UE may transmit the fourth powerPrefIndication to the network, when the timer T340 is not running. The UE may not transmit the fourth powerPrefIndication to the network, when the timer T340 is running. In one example, the UE may transmit the fourth powerPrefIndication to the network, after the timer T340 is expired. That is, the UE can change its power preference from Normal to lowPowerConsumption, according to a state (e.g., running, not running or expired) of the timer T340, after transmitting the third powerPrefIndication to the network.

In one example, the first powerPrefIndication, the second powerPrefIndication, the third powerPrefIndication, and the fourth powerPrefIndication may be included in a UEAssistanceInformation message. That is, the UE may transmit the UEAssistanceInformation message including a powerPrefIndication (e.g., the first powerPrefIndication, the second powerPrefIndication, the third powerPrefIndication, or the fourth powerPrefIndication) to the network for indicating a power preference.

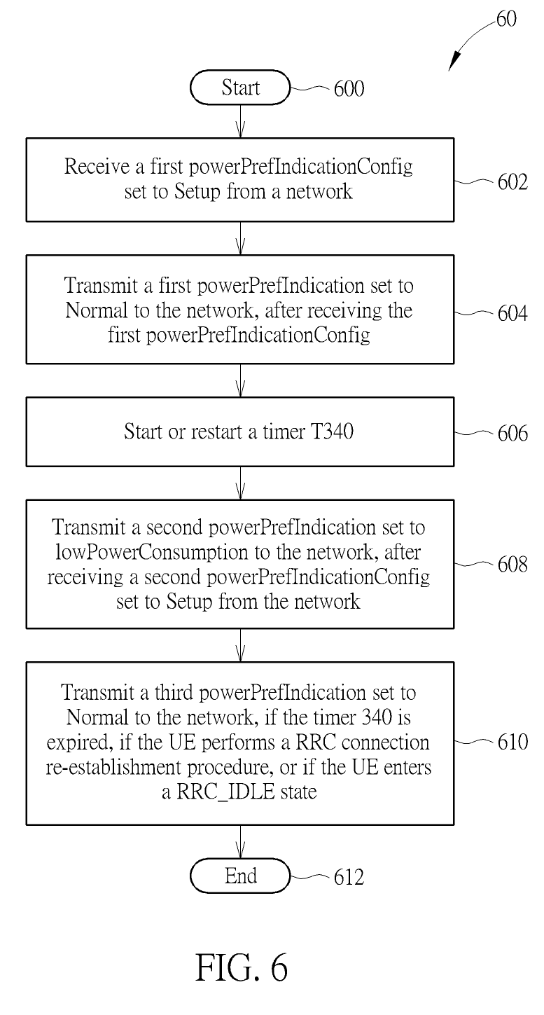

FIG. 6 is a flowchart of a process 60 according to an example of the present invention. The process 60 may be utilized in a UE for handling a power preference. The process 60 may be compiled into the program code 214 and includes the following steps:

Step 600: Start.

Step 602: Receive a first powerPrefIndicationConfig set to Setup from a network.

Step 604: Transmit a first powerPrefIndication set to Normal to the network, after receiving the first powerPrefIndicationConfig.

Step 606: Start or restart a timer T340.

Step 608: Transmit a second powerPrefIndication set to lowPowerConsumption to the network, after receiving a second powerPrefIndicationConfig set to Setup from the network.

Step 610: Transmit a third powerPrefIndication set to Normal to the network, if the timer 340 is expired, if the UE performs a radio resource control (RRC) connection re-establishment procedure, or if the UE enters a RRC_IDLE state.

Step 612: End.

According to the process 60, the UE may receive a first powerPrefIndicationConfig set to Setup from a network. The UE may transmit a first powerPrefIndication set to Normal to the network, after receiving the first powerPrefIndicationConfig. Then, the UE may start or restart a timer T340. After a while, the UE may transmit a second powerPrefIndication set to lowPowerConsumption to the network, after receiving a second powerPrefIndicationConfig set to Setup from the network. The UE may transmit a third powerPrefIndication set to Normal to the network, if the Timer 340 is expired, if the UE performs a RRC connection re-establishment procedure, or if the UE enters a RRC_IDLE state. The timer T340 is released (or stopped), when the UE enters the RRC_IDLE state. That is, the UE changes its power preference from lowPowerConsumption to Normal, if one of the above three conditions is satisfied. Thus, the problem of setting the power preference when the timer T340 is running is solved according to the process 60.

Realization of the process 60 is not limited to the above description. The following examples may be applied to the process 60.

In one example, the UE may perform the RRC connection establishment procedure, after entering the RRC_IDLE state. In one example, the first powerPrefIndication, the second powerPrefIndication, and the third powerPrefIndication may be included in a UEAssistanceInformation message. That is, the UE may transmit the UEAssistanceInformation message including a powerPrefIndication (e.g., the first powerPrefIndication, the second powerPrefIndication, or the third powerPrefIndication) to the network for indicating a power preference. In one example, the UE may postpone the transmission of the third powerPrefIndication for a time interval, before the timer T340 is expired. That is, the UE may postpone the procedure of changing its power preference to Normal, before the timer T340 is expired.

Those skilled in the art should readily make combinations, modifications and/or alterations on the abovementioned description and examples. Any of the above mentioned processes may be compiled into the program code 214. The abovementioned description, steps and/or processes including suggested steps can be realized by means that could be hardware, software, firmware, an electronic system, or combination thereof. An example of the means may be the communication device 20.

To sum up, the present invention provides a device and a method for handling power preference. In one example, the UE changes its power preference from lowPowerConsumption to Normal, by stopping the timer T340, or whether the timer T340 is running or not. In another example, the UE changes its power preference from lowPowerConsumption to Normal, if the timer 340 is expired, if the UE performs a RRC connection re-establishment procedure, or if the UE enters a RRC_IDLE state. As a result, the problem of setting the power preference when the timer T340 is running is solved according to the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device for handling a power preference, comprising:
a storage unit, for storing instructions of:
receiving a first powerPrefIndicationConfig set to Setup from a network;
transmitting a first powerPrefIndication set to Normal to the network, after receiving the first powerPrefIndicationConfig;
starting or restarting a timer T340; and
stopping the timer T340, if the communication device receives a second powerPrefIndicationConfig set to Release or Setup from the network, or if the communication device transmits a second powerPrefIndication set to lowPowerConsumption to the network after receiving a third powerPrefIndicationConfig set to Setup from the network; and
a processing circuit, coupled to the storage unit, configured to execute the instructions stored in the storage unit.

2. The communication device of claim 1, wherein the storage unit further stores instructions of:
receiving a fourth powerPrefIndicationConfig set to Setup from the network, after stopping the timer T340.
transmitting a third powerPrefIndication set to Normal to the network, after receiving the fourth powerPrefIndicationConfig.

3. The communication device of claim 1, wherein the first powerPrefIndication, the second powerPrefIndication, and the third powerPrefIndication are comprised in a UEAssistanceInformation message.

4. The communication device of claim 1, wherein the communication device receives a fifth powerPrefIndicationConfig set to Release from the network, before receiving the third powerPrefIndicationConfig.

5. The communication device of claim 4, wherein the communication device receives three powerPrefIndicationConfigs in sequence from the network, which are set to Setup, Release and Setup, respectively.

6. A communication device for handling a power preference, comprising:
a storage unit, for storing instructions of:
receiving a first powerPrefIndicationConfig set to Setup from a network;
transmitting a first powerPrefIndication set to Normal to the network, after receiving the first powerPrefIndicationConfig;
starting or restarting a timer T340;
transmitting a second powerPrefIndication set to lowPowerConsumption to the network after receiving a second powerPrefIndicationConfig set to Setup from the network; and
transmitting a third powerPrefIndication set to Normal to the network whether the timer T340 is running or not; and
a processing circuit, coupled to the storage unit, configured to execute the instructions stored in the storage unit.

7. The communication device of claim 6, wherein the storage unit further stores an instruction of:
receiving a third powerPrefIndicationConfig set to Release from the network, before receiving the second powerPrefIndicationConfig.

8. The communication device of claim 6, wherein the storage unit further stores an instruction of:
stopping or restarting the timer T340, if the timer T340 is running.

9. The communication device of claim 6, wherein the storage unit further stores an instruction of:
transmitting a fourth powerPrefIndication set to lowPowerConsumption to the network according to whether the timer T340 is running, after transmitting the third powerPrefIndication to the network.

10. The communication device of claim 9, wherein the communication device transmits the fourth powerPrefIndication to the network, when the timer T340 is not running.

11. The communication device of claim 9, wherein the communication device does not transmit the fourth powerPrefIndication to the network, when the timer T340 is running.

12. The communication device of claim 9, wherein the communication device transmits the fourth powerPrefIndication to the network, after the timer T340 is expired.

13. The communication device of claim 9, wherein the first powerPrefIndication, the second powerPrefIndication, the third powerPrefIndication, and the fourth powerPrefIndication are comprised in a UEAssistanceInformation message.

14. A communication device for handling a power preference, comprising:
a storage unit, for storing instructions of:
receiving a first powerPrefIndicationConfig set to Setup from a network;
transmitting a first powerPrefIndication set to Normal to the network, after receiving the first powerPrefIndicationConfig;
starting or restarting a timer T340;
transmitting a second powerPrefIndication set to lowPowerConsumption to the network, after receiving a second powerPrefIndicationConfig set to Setup from the network; and
transmitting a third powerPrefIndication set to Normal to the network, if the Timer 340 is expired, if the communication device performs a radio resource control (RRC) connection re-establishment procedure, or if the communication device enters a RRC_IDLE state; and
a processing circuit, coupled to the storage unit, configured to execute the instructions stored in the storage unit.

15. The communication device of claim 14, wherein the communication device performs the RRC connection establishment procedure, after entering the RRC_IDLE state.

16. The communication device of claim 14, wherein the first powerPrefIndication, the second powerPrefIndication, and the third powerPrefIndication are comprised in a UEAssistanceInformation message.

17. The communication device of claim 14, wherein the communication device postpones the transmission of the third powerPrefIndication for a time interval, before the timer T340 is expired.
